(19) United States
(12) Patent Application Publication
(10) Pub. No.: US 2023/0063464 A1
(43) Pub. Date: Mar. 2, 2023

(54) BLIND PULL CORD CONNECTOR

(71) Applicant: Tser Wen CHOU, Yorba Linda, CA (US)

(72) Inventor: Tser Wen CHOU, Yorba Linda, CA (US)

(21) Appl. No.: 17/496,571

(22) Filed: Oct. 7, 2021

(30) Foreign Application Priority Data
Sep. 2, 2021 (TW) 110210384

(51) Int. Cl. E06B 9/326; E06B 9/78

(52) U.S. Cl. CPC E06B 9/326; E06B 9/78; E06B 2009/785

(57) ABSTRACT

A blind pull cord connector has a cord passage section and a connection section. The cord passage section has more than one cord passage bodies, each of which is formed with a through hole. An inner face of each cord passage body is formed with a cut face. The connection section is passed through a punched hole of rear side of a blind slat, whereby the cord passage section is positioned on outer side of the slat. When the slat is horizontally opened or vertically closed, the connector structure is limited by the slat so that the connector is connected with the blind slat and naturally kept horizontal. In this case, a pull cord can be easily and quickly passed through the through holes of the cord passage bodies, whereby the frictional resistance against the pulling of the pull cord is reduced and the slats can be more tightly closed. In addition, by means of the restriction of the cord passage bodies of the cord passage section, a ladder cord and the pull cord are located. When the slats are displaced, under the pullback of the cord passage bodies, the positions of the slats can be automatically micro-adjusted to restore to a flush state.

### BACKGROUND OF THE INVENTION

### 1. Field of the Invention

The present invention relates generally to a blind pull cord connector, and more particularly to a blind pull cord connector, which can locate the blind slats, the pull cord and the ladder cord. In addition, the blind pull cord connector can make the slats more tightly closed.

### 2. Description of the Related Art

Please refer to FIG. 1, which shows an assembly of a conventional blind slat 10. Two ladder belts 1 are disposed on two sides of the slat 10 to downward extend to lateral sides of a bottom rail. More than two ladder cords 12 are connected between the two ladder belts 1 to restrict the slats and control the opening and closing of the slats. In addition, rings 11 are disposed on the ladder belts 1 for a pull cord 13 to pass through and then connect with a bottom end of the bottom rail. The tilter 13 serves to control the slats 10 and collectively lift the slats into an overlapping state or lower the slats into an open state. The conventional slat is located simply by means of the ladder cord 12, which is transversely bridged over the slat 10 to control the up and down opening and closing of the slat 10. When the slat 10 is operated and transversely displaced without being secured by the ladder belts 1 and the ladder cords 12, the slats 10 are apt to jump out to affect the flushness and appearance of the slats 10.

Referring to FIG. 2, in general, a blind slat 2 without any punched hole should be cut with a notch 20 on the edge of the blind slat 2 for engaging the ladder belt 21 therein. In this case, when the slat 2 is lifted or lowered, the ladder belt 21 is unlikely to jump out. However, when the slat 2 is closed, the ladder belt 21 is still apt to jump out. Under such circumstance, the tightness of the slats 2 is poor. Moreover, in case that the slats 2 are positioned outside the window, the ladder belt 21 often slips out under blowing of the wind. This will affect the effect of the slats 2.

Furthermore, the conventional fitting rings for locating the pull cord are generally sewn on the ladder belt in accordance with the distance between the slats for the pull cord to correspondingly pass through the fitting rings and locate therein. Because the manufacturing process for the ladder belt with the fitting rings is complicated, the price is always very high. This fails to meet the requirement of the current stage.

The lift cord is passed through a rear end of a string needle. Thereafter, the string needle is further passed out from the lower end of the punched hole of the slat to hook the string body downward so as to form a fitting ring body. This step is repeated from upper side to lower side to sequentially complete the fitting rings. Then the pull cord is passed through the fitting ring bodies to restrict and locate the pull cord.

It can be known from the above step that not only it is complicated to form the conventional fitting rings for locating the pull cord, but also the installation of the conventional fitting rings necessitates a professional person. As a result, the manufacturing cost is very high. By using traditional notches only, after the blind slats are up and down displaced, the respective slats cannot be located in a flush state. Also, the pull cord and the ladder belt cannot restore to their home positions. This leads to quite messy appearance of the blind. This is why loops are required and why our connectors are an improvement.

### SUMMARY OF THE INVENTION

It is therefore a primary object of the present invention to provide a blind pull cord connector having a cord passage section and a connection section. The connection section is passed through a punched hole of rear side of a blind slat, whereby the connector is movably connected with the slat. The cord passage section has more than one cord passage bodies. A pull cord is passed through the cord passage bodies, whereby the connector is connected with the slat and the pull cord and located without freely moving. In addition, by means of a cut face structure of inner face of the connector and the arced body structure of the connection section passing through the punched hole, when the connector is rotated, the slat restricts the connector from large-amplitude rotating. Therefore, the connector is naturally kept in a horizontal state. In this case, the through holes of the cord passage bodies are aligned with each other so that the pull cord can be quickly passed through the through holes of the cord passage bodies, whereby the frictional resistance against the pulling of the pull cord is reduced and the slats can be more tightly closed. In addition, by means of the restriction of the cord passage bodies of the cord passage section, the ladder cord and the pull cord are located in a specific position. When the slats are displaced, under the pullback of the cord passage bodies, the positions of the slats can be automatically micro-adjusted to restore to a flush state.

To achieve the above and other objects, the blind pull cord connector of the present invention mainly includes:
a cord passage section including more than one cord passage bodies, each cord passage body being formed with a through hole, an inner face of each cord passage body being formed with more than one cut faces; and
a connection section passing through a punched hole of rear side of a blind slat, the connection section being connected with the punched hole as an arced body structure, the connection section being connected with outer circumferences of the cord passage bodies of the cord passage section as an integrated structure.

Accordingly, the connector is movably connected with the slat. The pull cord is passed through the through holes of the cord passage bodies of the cord passage section, whereby the connector is connected with the slat and the pull cord and located without freely moving. In addition, by means of the cut face structure of the inner face of the connector and the arced body structure of the connection section passing through the punched hole, when the slats are closed to make the connector rotate, due to the thickness of the slats, the slats will abut against the cut faces of the inner faces of the connectors and the inner faces of the connection sections so that the connectors cannot be large-amplitude rotated. In this case, the connectors can keep in a horizontal state to connect with the slats with the through holes of the cord passage bodies in alignment with each other. Accordingly, the pull cord can be quickly passed through the through holes to the bottom rail. Therefore, the frictional resistance between the pull cord and the through holes of the cord passage bodies so that the pull cord can normally function and the slats can be more tightly closed. In addition, by means of the restriction of the cord passage bodies of the cord passage section, the ladder cord and the pull cord are located in a specific position. When the slats are displaced, under the pullback of the cord passage bodies, the positions of the slats can be automatically micro-adjusted to restore to a flush state.

In addition, the blind pull cord connector of the present invention allows those who are less skilled to assemble faster with greater efficiency at a reduced cost in labor.

The present invention can be best understood through the following description and accompanying drawings, wherein:

### BRIEF DESCRIPTION OF THE DRAWINGS

FIG. 1 is a perspective view showing the arrangement of the ladder belts and ladder cords of a conventional blind slat;

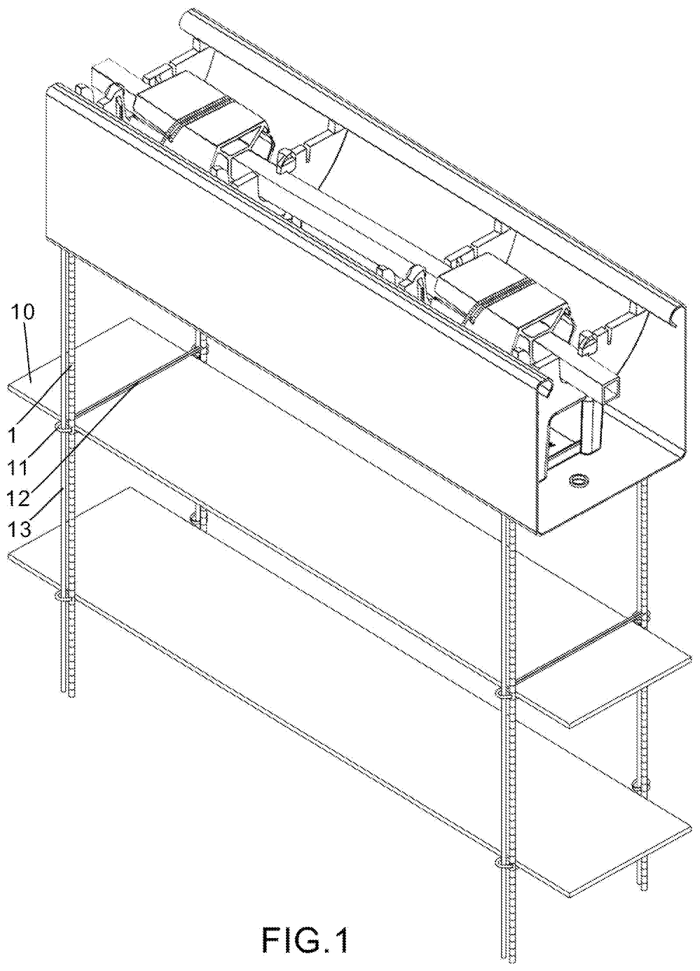

FIG. 2 is a perspective view showing the structure of the conventional blind slat;

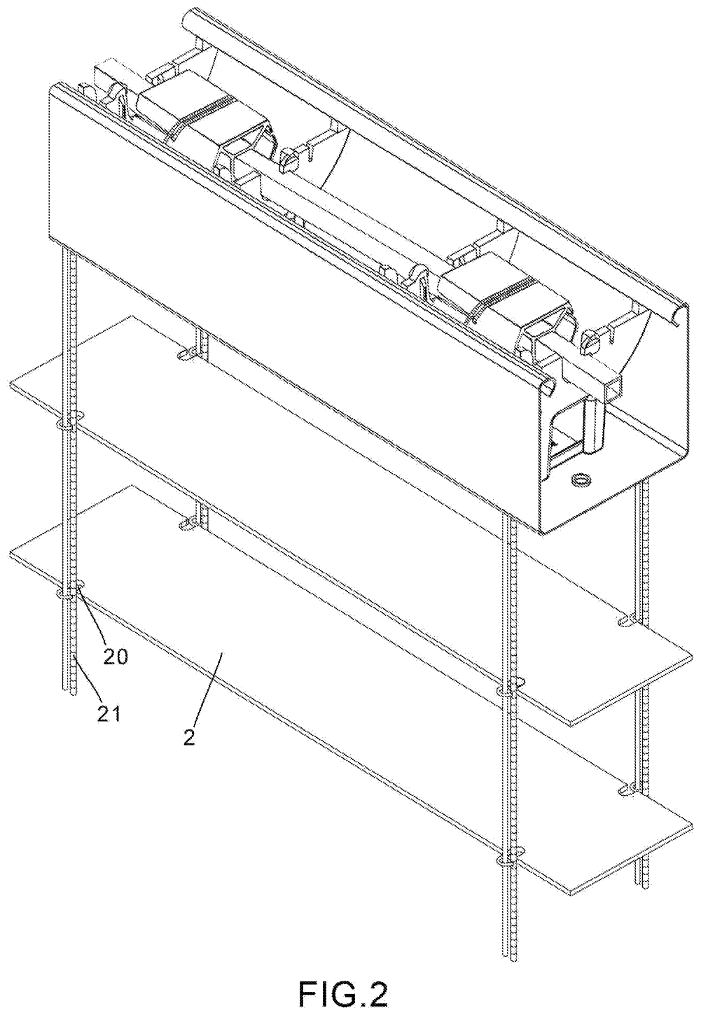

FIG. 3 is a perspective view of the connector of the present invention;

FIG. 4 is a perspective exploded view showing the installation of the connector of the present invention;

FIG. 5 is a perspective view showing that the connector of the present invention is passed through the punched hole of the blind slat;

FIG. 6 is a perspective view showing that the connector of the present invention is connected with the blind slat;

FIG. 7 is a top view showing that the connector of the present invention is connected with the blind slat;

FIG. 8 is a side view showing that the connector of the present invention is connected with the blind slat;

FIG. 9 is a perspective view showing that the pull cord is passed through the connector of the present invention;

FIG. 10 is a perspective view showing that the connector of the present invention is completely connected with the blind slat;

FIG. 11 is a perspective rear view showing that the connector of the present invention is connected with the blind slat;

FIG. 12 is an inner side view showing that the layout of the pull cord of the present invention is micro-adjusted;

FIG. 13 is an inner side view showing that the layout of the pull cord of the present invention is completed;

FIG. 14 is an outer side view showing that the layout of the pull cord of the present invention is micro-adjusted;

FIG. 15 is an outer side view showing that the layout of the pull cord of the present invention is completed;

FIG. 16 is a side view showing that the blind slats of the present invention are closed;

FIG. 17 is a perspective view of another embodiment of the connector of the present invention;

FIG. 18 is a perspective exploded view showing the installation of the other embodiment of the connector of the present invention;

FIG. 19 is a perspective view showing that the installation of the other embodiment of the connector of the present invention is completed;

FIG. 20 is a top view showing that the other embodiment of the connector of the present invention is passed through the punched hole of the blind slat;

FIG. 21 is a side view showing the other embodiment of the connector of the present invention;

FIG. 22 is a perspective view showing that the pull cord is passed through the other embodiment of the connector of the present invention; and

FIG. 23 is a perspective view showing that the pull cord is completely passed through the other embodiment of the connector of the present invention.

### DETAILED DESCRIPTION OF THE PREFERRED EMBODIMENTS

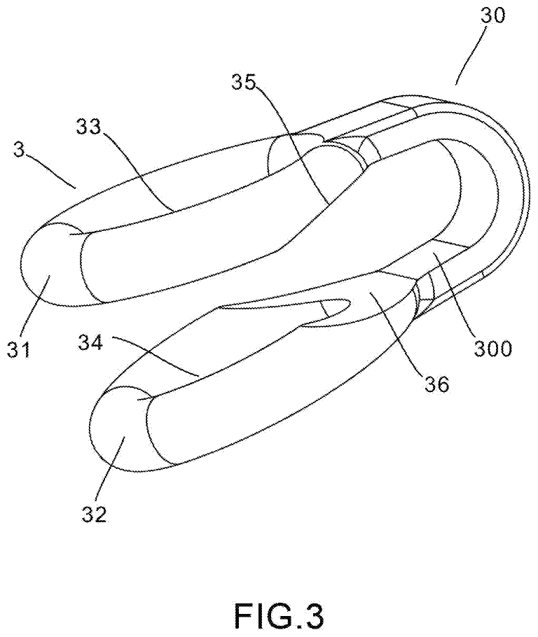

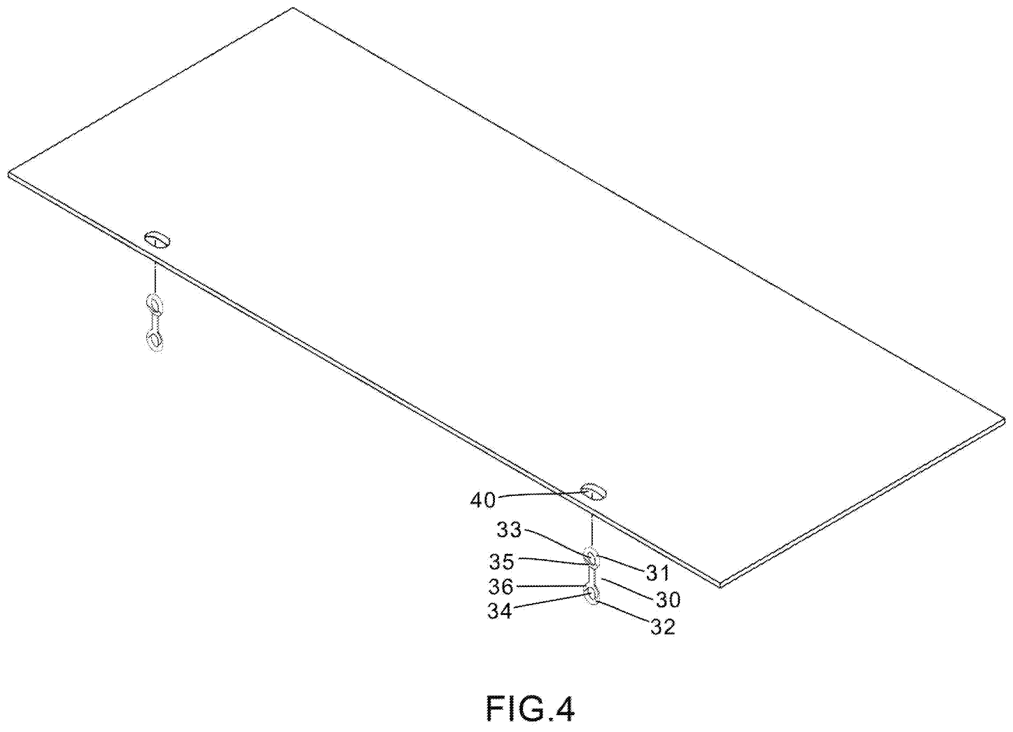

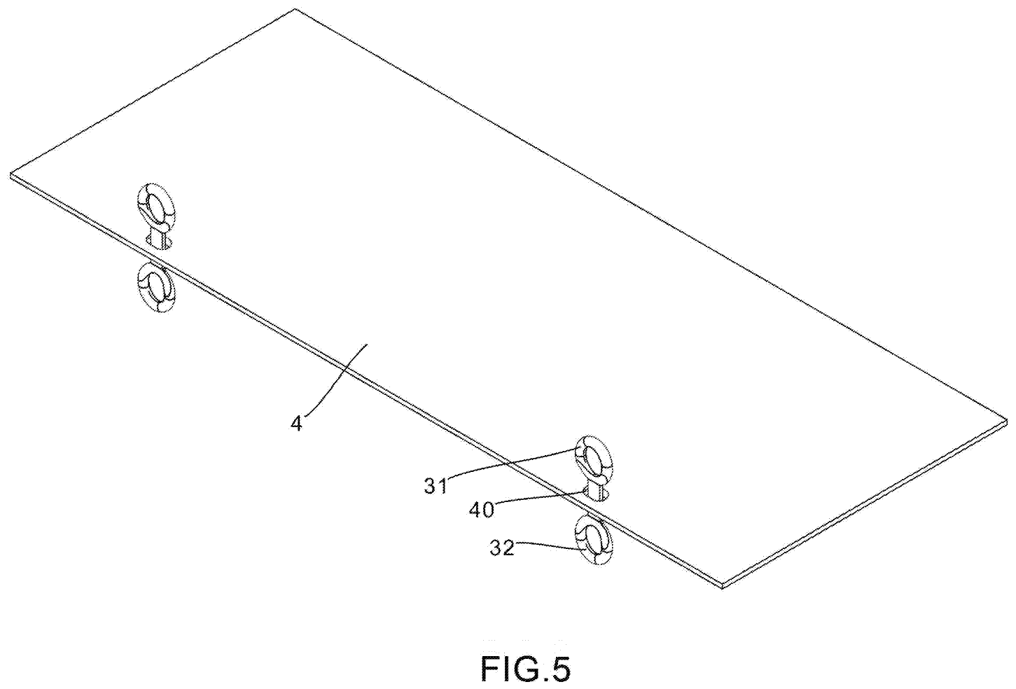

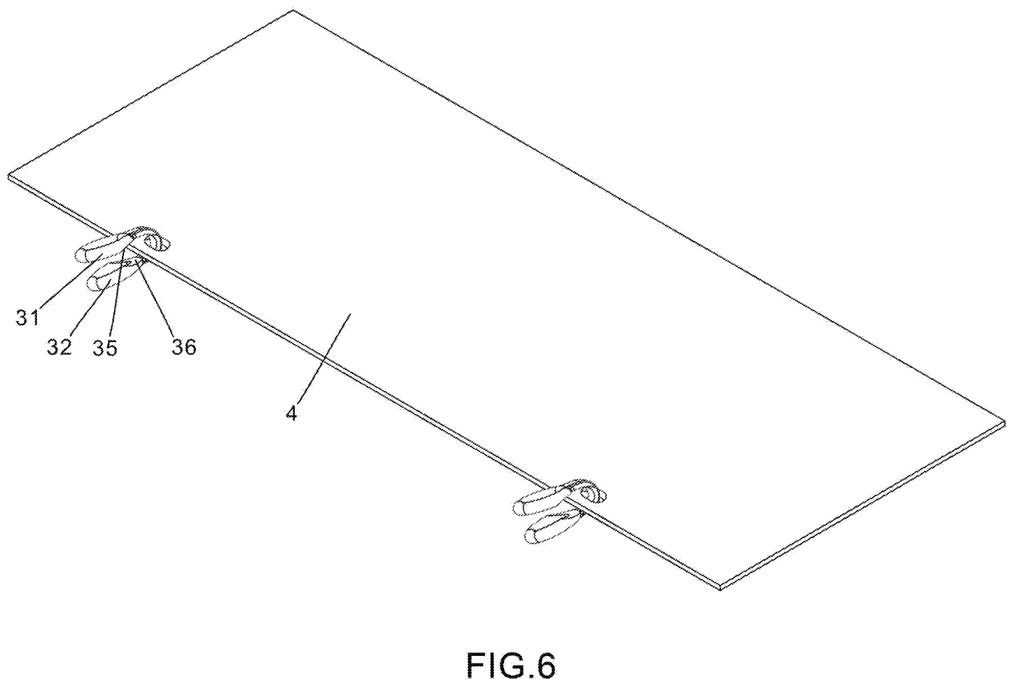

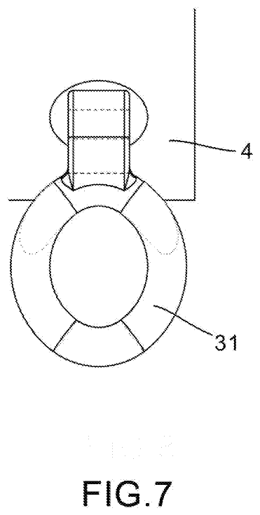

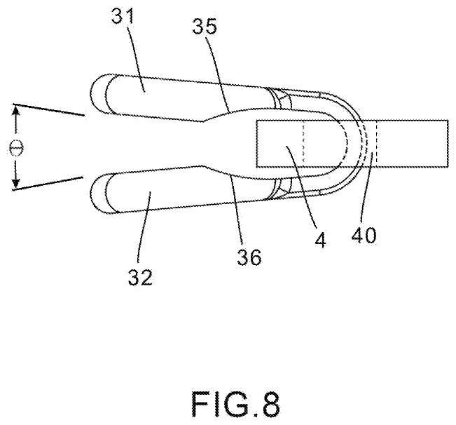

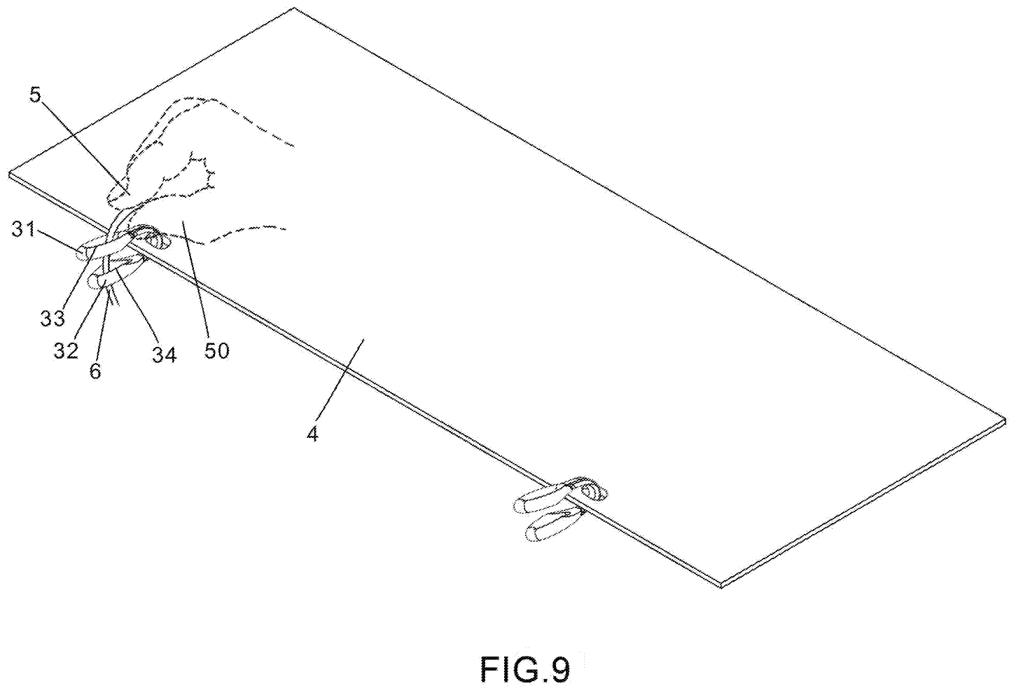

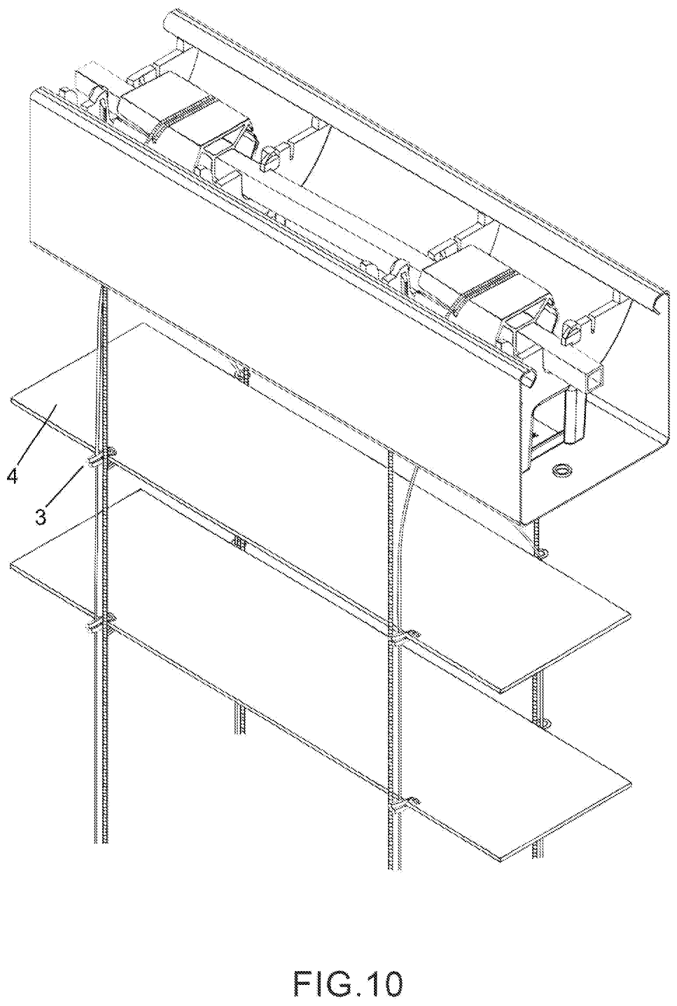

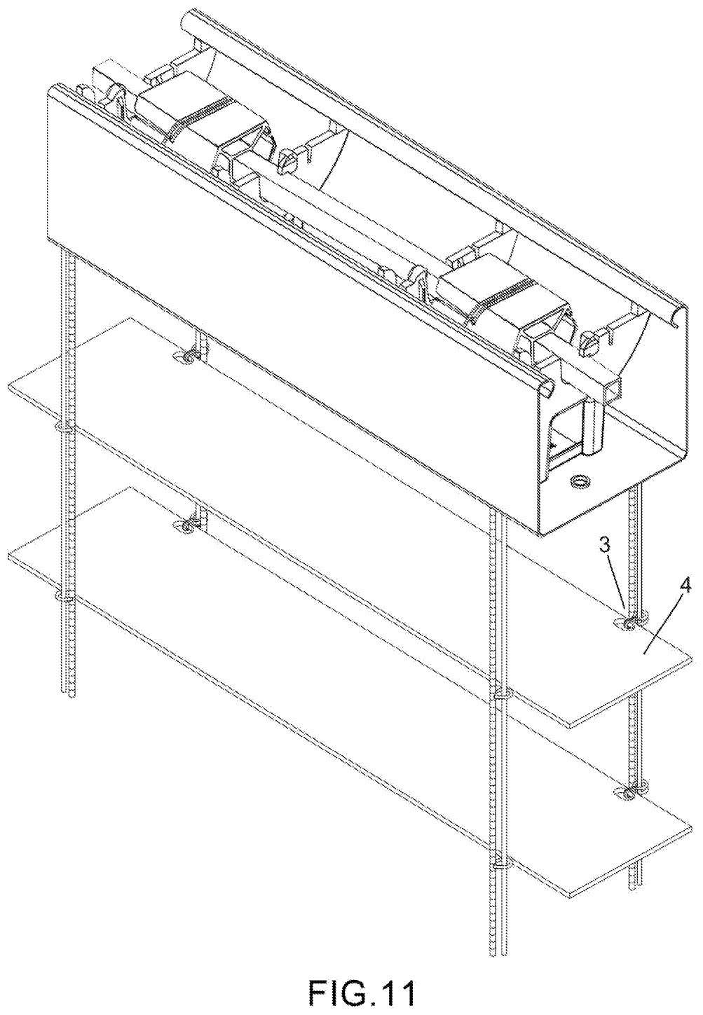

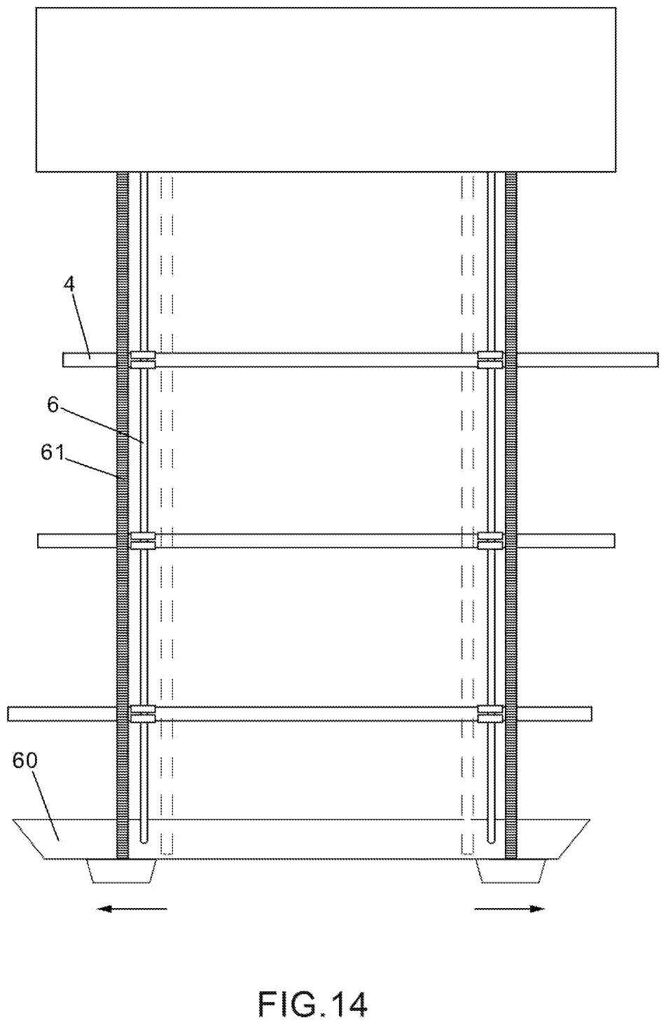

Please refer to FIG. 3, which is a perspective view of a preferred embodiment of the blind pull cord connector of the present invention. The main structure of the blind pull cord connector includes a cord passage section 3 and a connection section 30. The cord passage section 3 has more than one cord passage bodies. In this embodiment, there are two cord passage bodies 31, 32 for illustration purposes. The two cord passage bodies 31, 32 are respectively formed with two through holes 33, 34. Each of the two cord passage bodies 31, 32 has a cylindrical cross section. The connection section 30 is an arced body structure connected between the two cord passage bodies 31, 32 to form an integrated structure. In addition, each of the two cord passage bodies 31, 32 has a connection end connected with the connection section 30. Each of the connection ends is formed with a cut face 35, 36. The cut faces 35, 36 extend to connect with an inner side plane face 300 of the connection section 30. The connector of the present invention is installed in such a manner (as shown in FIGS. 4 and 5) that the cord passage body 31 is passed through an elliptic punched hole 40 on a rear side of a blind slat 4, whereby the two cord passage bodies 31, 32 are respectively positioned on upper and lower sides of the blind slat 4. Then the two cord passage bodies 31, 32 are folded to outer side of the slat 4 toward each other to contain a small angle (as shown in FIGS. 6 and 7). The connection section 30 is bent and passed through the punched hole 40 of the slat 4 and is in a freely rotatable state. As aforesaid, the inner faces of the two cord passage bodies 31, 32 are formed with the cut faces 35, 36. Therefore, when the two cord passage bodies 31, 32 of the connector are rotated, the cut face 35 will contact the slat 4 and cannot further rotate so that the two cord passage bodies 31, 32 can keep horizontally overlapping (as shown in FIG. 8). In this case, the two through holes 33, 34 are aligned with each other. Then a pull cord 6 is pinched by an index finger 5 and a thumb 50 to pass through the central through holes 33, 34 (as shown in FIG. 9) and connect with a bottom rail 60 (as shown in FIG. 14). By means of this step, the connector is completely installed on one side of each slat 4 (as shown in FIGS. 10 and 11).

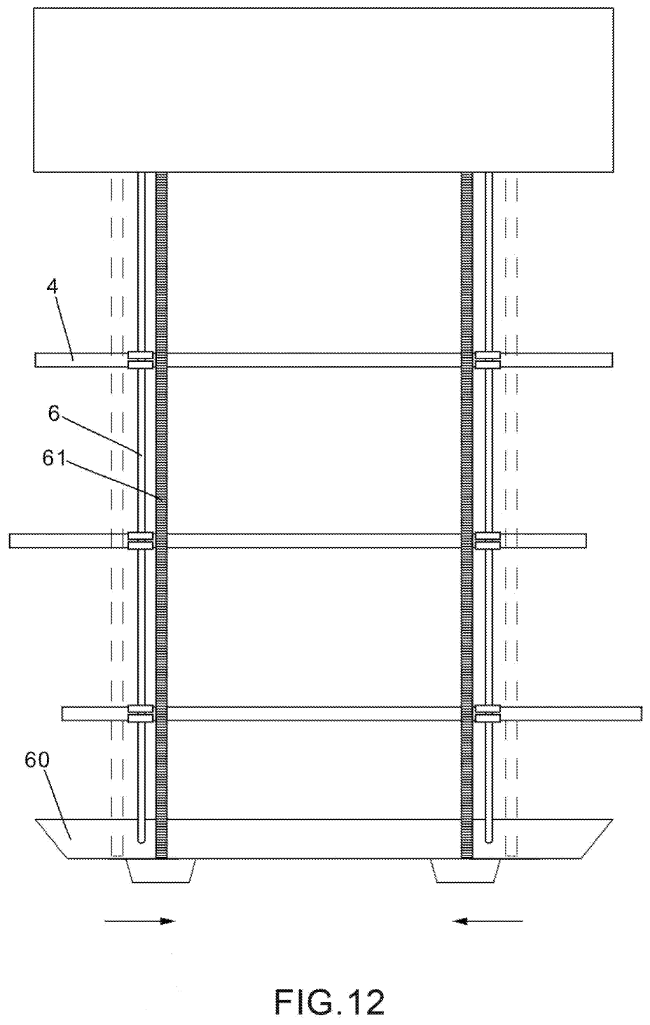

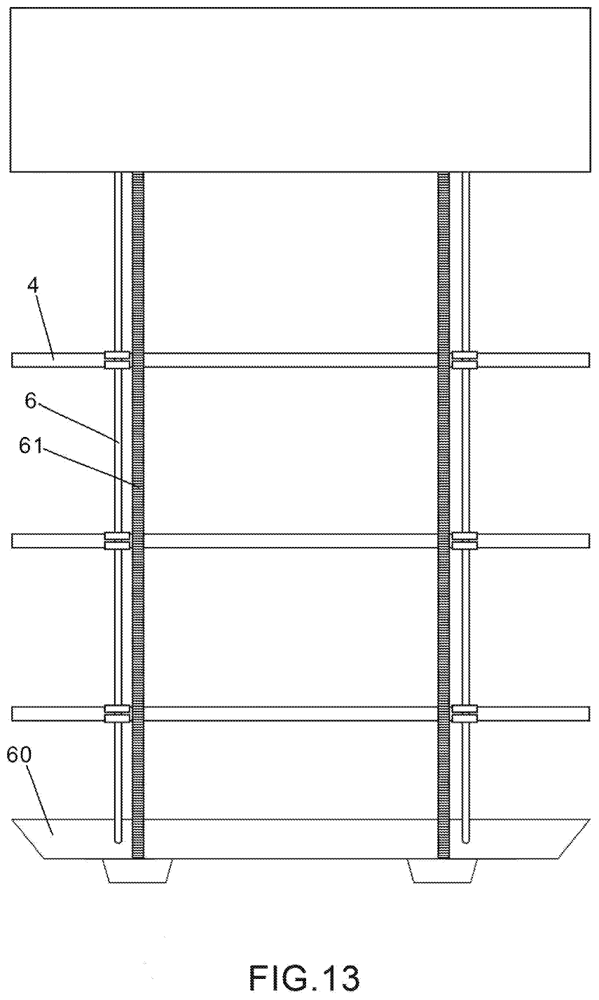

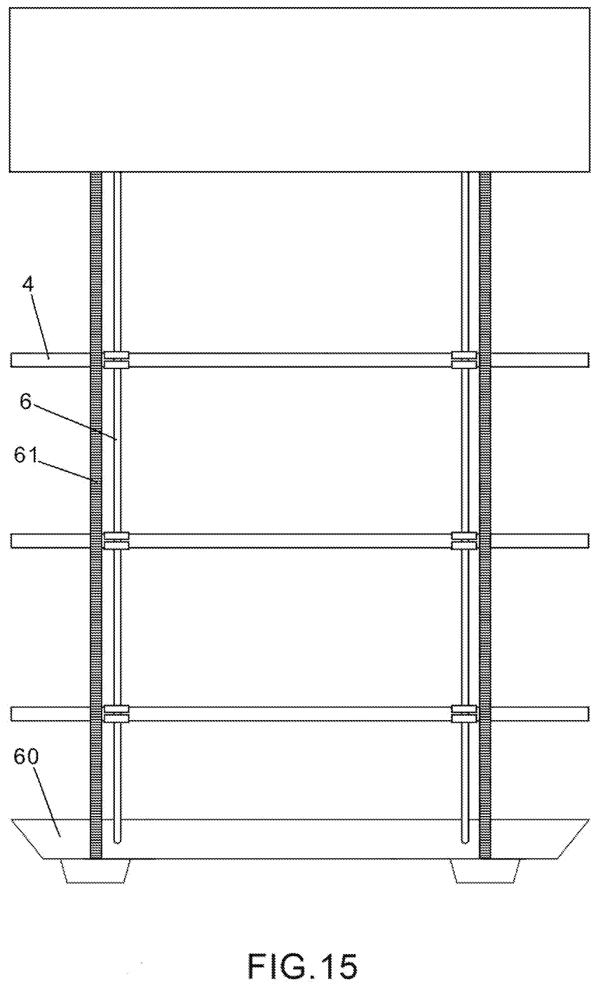

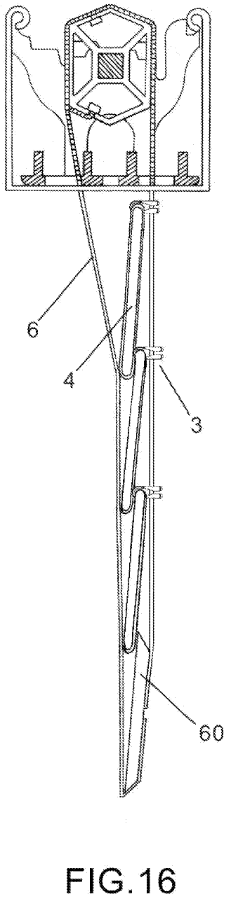

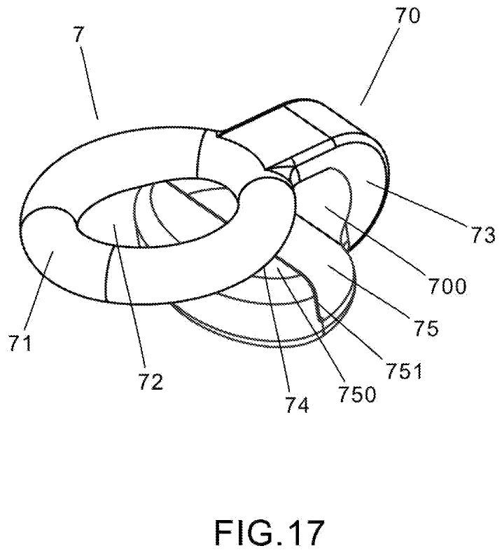

Please refer to FIGS. 12 to 15, which show the core of the technique of the present invention. After the connectors of the present invention are installed on the blind slats 4, the pull cord 6 is passed through the through holes 33, 34 of the connectors to connect with the bottom rail 60. By means of the connectors, the pull cord 6 and the ladder cord 61 as well as the slats 4 are kept in a fixed position. The two through holes 33, 34 of the two cord passage bodies 31, 32 are aligned with each other so that when pulling the pull cord 6, the frictional resistance between the pull cord 6 and the two cord passage bodies 31, 32 is reduced so as not to affect the function of the pull cord 6. In addition, the pull cord 6 is cooperatively connected with the slats 4 and the bottom rail 60 via the connectors so that a restriction effect is achieved. After the slats 4 are operated and opened/closed and when the slats 4 are displaced, under the gravity and the pullback of the two cord passage bodies 31, 32, the slats 4 can be automatically micro-adjusted to restore to their home positions and keep in a horizontally flush state without freely displacing. Therefore, no matter whether the ladder cord 61 is arranged on the inner side of the pull cord 6 (as shown in FIGS. 14 and 15) or disposed on the outer side of the pull cord 6 (as shown in FIGS. 16 and 17), under the restriction and pullback of the connectors, the ladder cord 61 and the pull cord 6 can be kept located. Also, when the slats 4 are closed and the connectors are rotated, due to the thickness of the slats 4, the slats 4 will abut against the cut faces 35 of the inner faces of the cord passage bodies 31 of the connectors and the inner faces of the connection sections so that the connectors cannot be large-amplitude rotated. In this case, the connectors can only keep in a horizontal state to connect with the slats with the through holes of the cord passage bodies in alignment with each other. Accordingly, the pull cord 6 can be easily and quickly passed through the through holes to the bottom rail, whereby the slats 4 can be more tightly closed (as shown in FIG. 16).

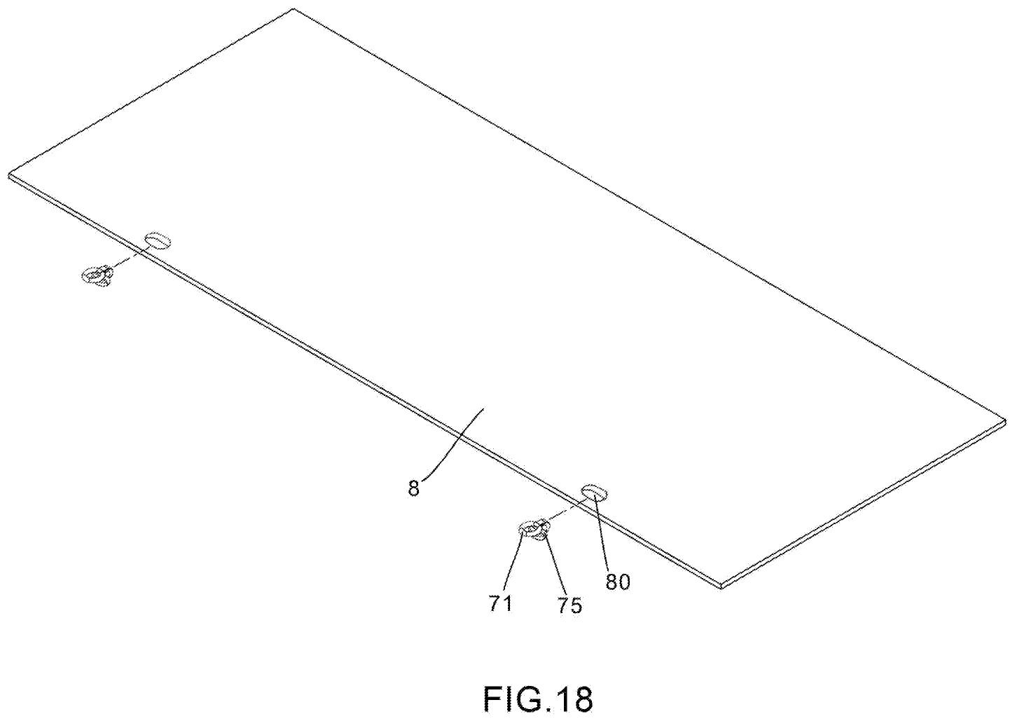

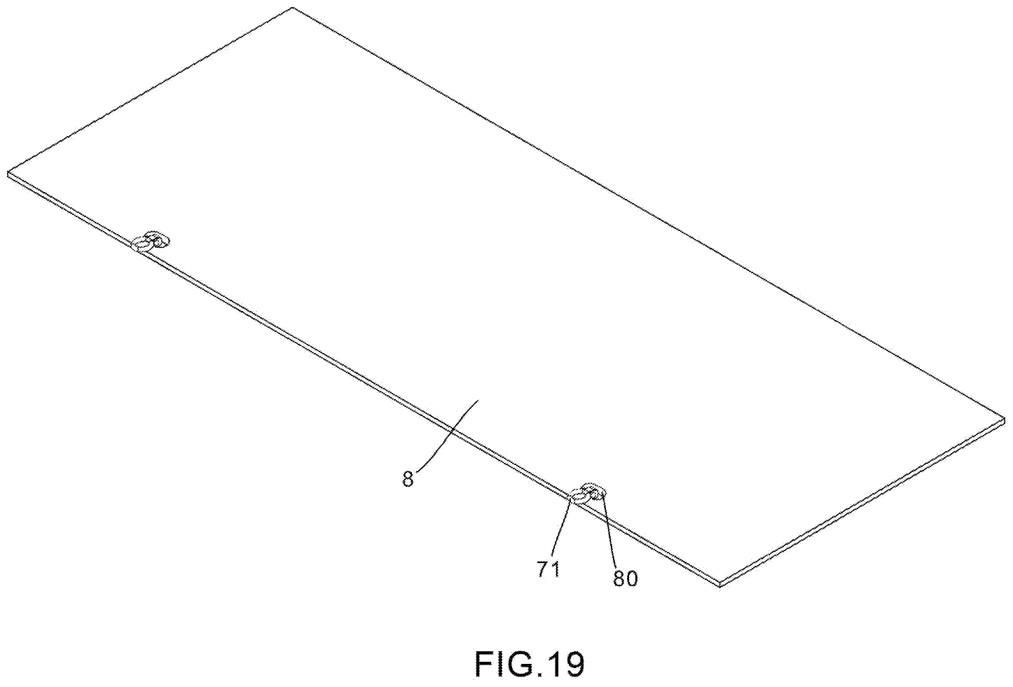

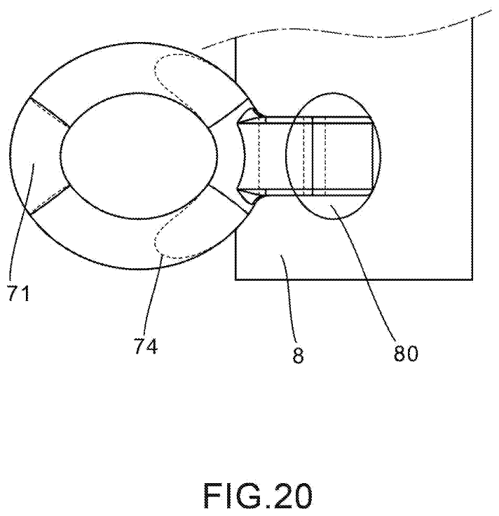

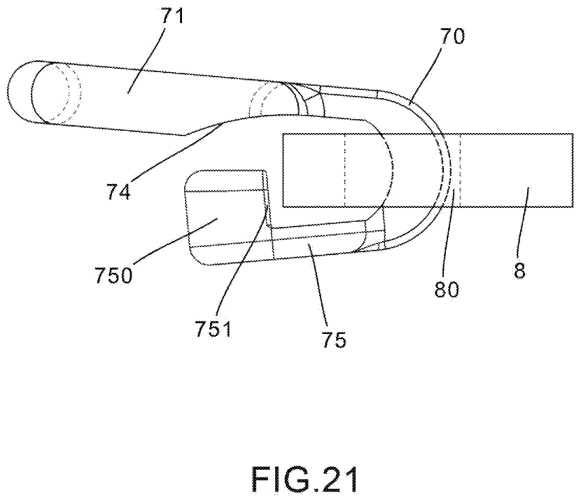

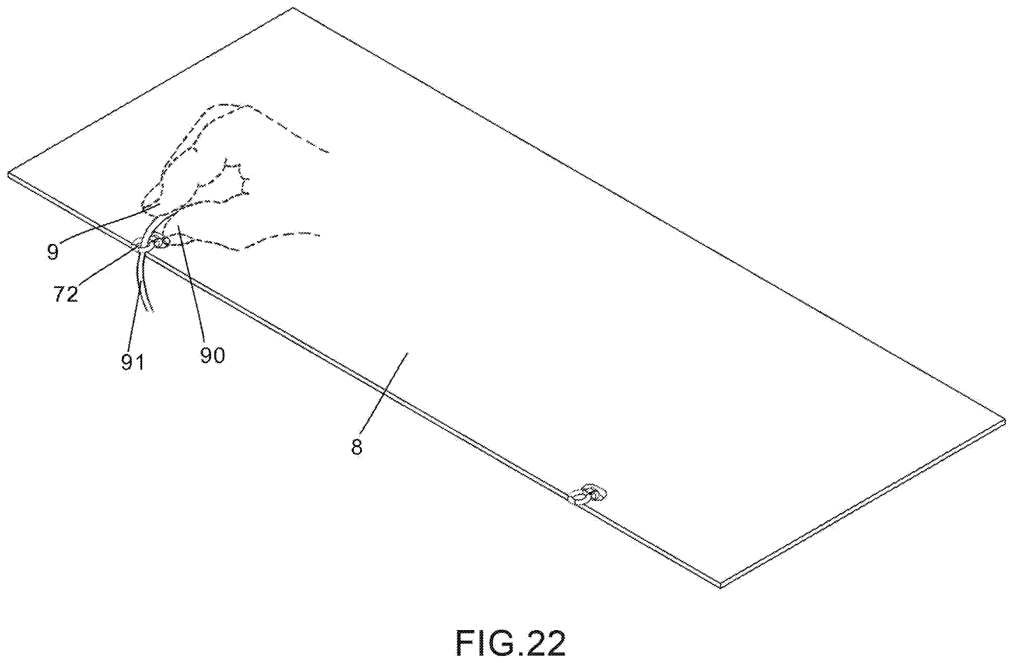

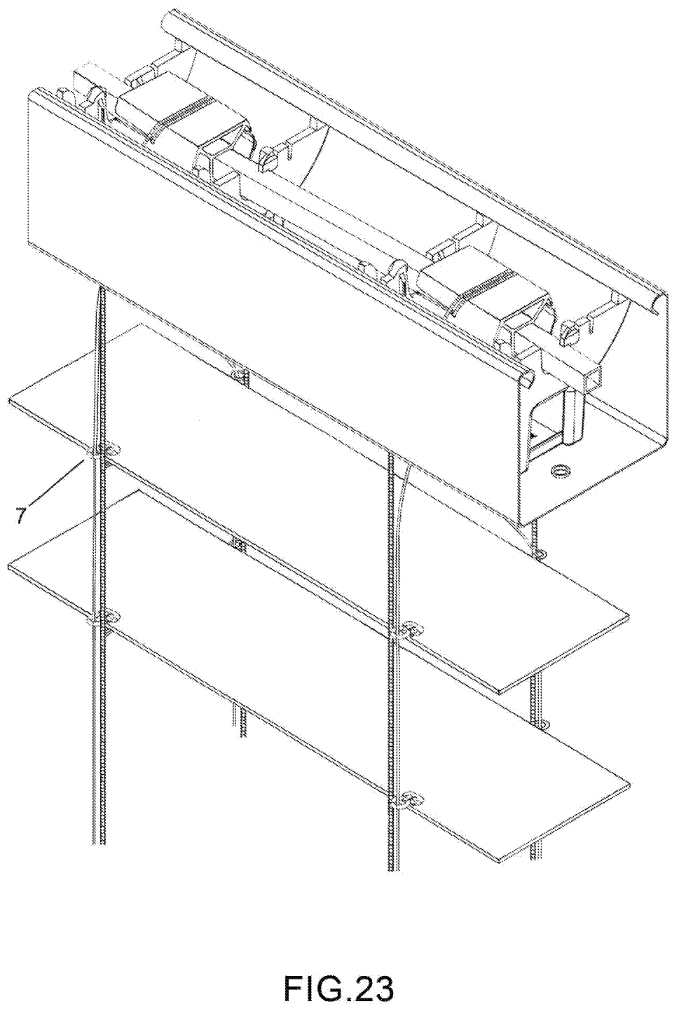

Please now refer to FIG. 17, which shows a second embodiment of the blind pull cord connector of the present invention. The main structure of the blind pull cord connector includes a cord passage section 7 and a connection section 70. The cord passage section 7 has a ring 71 formed with a central through hole 72. The ring 71 has a cylindrical cross section. The connection section 70 is a plane plate structure 73 one end of which is connected with outer circumference of the ring 71 to form an integrated structure. In addition, the ring 71 has a connection end connected with the connection section 70. An inner face of the connection end is formed with a cut face 74 (as shown in FIG. 21). The cut face 74 extends to an upper end plane face 700 of the connection section 70. The other end of the connection section 70 is integrally connected with more than one stop sections 75. A raised stop block 750 integrally extends from outer circumference of front edge of the stop section 75. A front end of the stop block 750 is formed with a stop face 751 to form the main body of the connector. According to the second embodiment, the connector of the present invention is installed in such a manner (as shown in FIG. 18) that the ring 71 is passed through an elliptic punched hole 80 on a rear side of a blind slat 8, whereby the ring 71 and the stop section 75 are respectively positioned on upper and lower sides of the blind slat 8. Then the ring 71 and the stop section 75 are folded to outer side of the slat 8 toward each other and closed (as shown in FIGS. 19 and 20). The connection section 70 is bent and passed through the punched hole 80 of the slat 8. As aforesaid, the inner face of the ring 71 is formed with the cut face 74. Therefore, when the ring 71 of the connector is rotated, the cut face 75 of the inner face will contact the slat 8 and cannot further rotate so that the connector can be installed and kept in a horizontal state. Accordingly, the ring 71 and the stop section 75 can be overlapped and kept in a horizontal state (as shown in FIG. 21). In this case, the stop face 751 of the stop block 750 of the stop section 75 can stop the slat 8 and make it impossible to extract the ring 71 from the punched hole 80. Then a pull cord 91 is pinched by an index finger 9 and a thumb 90 to pass through the central through hole 72 and connect with the bottom rail (as shown in FIG. 22). By means of this step, the connector is completely installed on one side of each slat 8 (as shown in FIG. 23).

The above embodiments are only used to illustrate the present invention, not intended to limit the scope thereof. Many modifications of the above embodiments can be made without departing from the spirit of the present invention.

What is claimed is:

1. A blind pull cord connector connected with a punched hole of rear side of a blind slat, the blind pull cord connector comprising a cord passage section and a connection section, the cord passage section having more than one cord passage bodies, each cord passage body being formed with a through hole, the connection section being connected with outer circumferences of the cord passage bodies to connect the cord passage bodies with each other, an inner face of each cord passage body of the cord passage section being formed with more than one cut faces, the cut faces extending to connect with the connection section, the connection section having two free ends passing through the punched hole of the rear side of the blind slat, the free ends being arced body structures connected with the outer circumferences of the cord passage bodies of the cord passage section and movably connected with the blind slat, whereby by means of the connector structure in the form of an arced body connected with the blind slat, the rotational amplitude of the connector is limited by the blind slat to keep the cord passage section in a horizontal state so that a pull cord can be easily and quickly passed through the through holes of the cord passage bodies, whereby the frictional resistance against the pulling of the pull cord is reduced and the blind slats can be more tightly closed, by means of the restriction of the cord passage bodies of the cord passage section, a ladder cord and the pull cord being located, when the blind slats are displaced, under the pullback of the cord passage bodies, the positions of the blind slats can be automatically micro-adjusted to restore to a flush state.

2. The blind pull cord connector as claimed in claim 1, wherein each cord passage body has a cylindrical cross section.

3. The blind pull cord connector as claimed in claim 1, wherein the punched hole of the blind slat is an elliptic hole.

4. The blind pull cord connector as claimed in claim 1, wherein the connection section is a plane plate structure.

5. The blind pull cord connector as claimed in claim 1, wherein the connection section is a cylindrical body structure.

6. The blind pull cord connector as claimed in claim 1, wherein the cord passage bodies and the connection section are integrally connected and formed.

7. The blind pull cord connector as claimed in claim 1, wherein the cord passage body is ring-shaped.

8. A blind pull cord connector connected with a punched hole of rear side of a blind slat, the blind pull cord connector comprising a cord passage section, a connection section and a stop section, wherein:
the cord passage section has a ring, the ring being formed with a central through hole, an inner face of the ring being formed with a cut face, the cut face extending to connect with an upper end plane face of the connection section as an integrated structure;
the connection section is a plane plate structure having an upper plane face and a lower plane face, one end of the connection section being connected with an outer circumference of the cord passage section, the other end of the connection section being connected with the stop section as an integrated structure; and
the stop section is connected with one end of the connection section, a raised stop block upward extending from outer circumference of front edge of the stop section, a front end of the stop block being formed with a stop face for stopping the blind slat.
